(19) United States
(12) Patent Application Publication
(10) Pub. No.: US 2010/0136283 A1
(43) Pub. Date: Jun. 3, 2010

(54) REMOVABLY ATTACHABLE PANELS FOR USE WITH SCREEN STRUCTURES

(76) Inventor: Russell M. Wolfe, Hollywood, FL (US)

Correspondence Address: MALIN HALEY DIMAGGIO BOWEN & LHOTA, P.A., 1936 S ANDREWS AVENUE, FORT LAUDERDALE, FL, 33316, US

(21) Appl. No.: 12/630,180

(22) Filed: Dec. 3, 2009

Related U.S. Application Data
(60) Provisional application No. 61/119,399, filed on Dec. 3, 2008.

(51) Int. Cl. B32B 3/06

(52) U.S. Cl. 428/100

(57) ABSTRACT

An apparatus and method for attaching a separate panel onto a screen is disclosed herein. The removable panel can include any number of logos or designs and is used for a variety of functions including increasing the aesthetic appeal of a screen, refurbishing tears within the screen, reducing air-flow or light transmission, or providing enhanced visibility of a screened opening. The panel is attached to the screen through a series of hooks that extend out from the rear surface of the panel. These hooks thread through the planar surface of the screen webbing so as to adequately hold the panel adjacent to the screen. The hooks are flexible enough to allow for continuous attachment and detachment of the panel without damaging the screen or requiring additional tools to accomplish same.

### CROSS REFERENCE TO RELATED APPLICATIONS

This application claims the benefit of provisional U.S. Patent Application Ser. No. 61/119,399 filed on Dec. 3, 2009.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates generally to the method and design of a removable panel which attaches to a mesh screen by utilizing a plurality of hooks of various shapes and sizes which connect through the open weave design of the screen material.

2. Description of Related Art

Screens are used commercially and residentially as a means for allowing airflow within a building, while still providing a barrier against insects or large airborne particles. Commonly formed from metal wire, fiberglass, or synthetic fiber, screens have a woven appearance which creates a repeating pattern of uniform open and closed spaces along its planar surface. Screen devices allow for visibility though a window or door opening, whereas curtains or a solid door would reduce natural inflow of light and fresh air circulation.

Panels and patches may be attached to screens in order to improve aesthetic appearance, to enhance the visibility of the screen itself, or to provide a protective barrier for the screen. A number of inventions relating to screen coverings and related attachment methods are described in the prior art.

U.S. Pat. No. 243,962 issued to Palmer, discloses a method for painting fabrics onto a screen. U.S. Pat. No. 1,764,398 issued to Fitzgerald, discloses a method for decorating screens whilst allowing for pass-through of light and air around the decorative portion. U.S. Pat. No. 1,749,755 issued to Downer, discloses device and method for patching a screen with an additional section of mesh enclosed in and welded to a metal frame assembly and connected with metal spurs. U.S. Pat. No. 3,308,875 issued to Abrams, discloses a method for attaching decorative panels to a screen using a pre-formed frame which utilizes a locking means thereby connecting frame to screen. U.S. Pat. No. 4,163,817 issued to DiCarlantonio, discloses a method and device for repairing tears in the screen whereby two identically-shaped decorative pieces are placed on either side of the tear and interlock to maintain positioning about the tear. U.S. Pat. No. 5,785,792 issued to Locke et al., discloses a screen panel for use in doors which is air-permeable and visually transparent, but permanently affixed to the door frame, and where the decorative portion remains non-permeable.

U.S. Pat. No. 5,730,196 issued to Frament, U.S. Pat. No. 6,794,011 issued to Allard, U.S. Pat. No. 6,984,283 issued to Noriega, and U.S. Pat. No. 6,017,608 issued to Braun et al., each disclose a method and device for attaching decorative items to enhance visibility of the screen.

The above mentioned prior art fails to disclose a device or method for easily attaching and detaching various-sized panels onto screens. Furthermore, the inventions of the prior art utilize bulky hook or alternative attachment systems that are not adapted for use with the uniform weave pattern inherent in screens materials. Additionally, design patterns have historically been created using non-permeable materials, such that light and or air-flow was affected by the design. As a result, there exists a need for a device and method of attaching decorative panels onto screens of various sizes. Furthermore, such a device must allow for the continuous attachment and detachment of the panel enabling repeated usage, without damaging the panel or the primary screen, such that the ornamentation does not detract from its utility.

### BRIEF SUMMARY OF THE INVENTION

The panel attachment system of the present invention includes a device and method for attaching a panel onto a screen. The panel that is attached to the screen can be made from any suitable thin layer of material i.e., mesh or a uniform flat layer fabric. The panel serves a number of functions including but not limited to decorating, protecting, covering, or providing a visual warning of the presence of a screen.

The panel is secured directly to the screen through a series of hooks that extend out from the back of the panel. These hooks are threaded through the natural weave of the screen, thereby adhering the panel onto the screen. A variety of different hook devices can be used in the method and device of the present invention, including a double pointed hook, single pointed hook, pointed mushroom hook, or arrow hook. Each individual hook may include multiple heads to create a hook that effectively engages the screen. The hooks are made from a material that is flexible enough to allow for the hook to be threaded through the mesh grating of the screen, whilst rigid enough for repeated use. Furthermore, the hooks can be spaced along the back of the panel in any configuration that provides sufficient support for the panel to remain fixedly attached. In a preferred embodiment, double pointed hooks featuring two pointed prongs extending from the top of the shaft bent inwardly at acute angles towards the panel are contemplated.

It is one object of the present invention to provide a means for securely attaching variably designed panels to a screen.

It is another object of the present invention to provide a means for attaching an air-permeable and light-permeable decorative panel to a screen.

It is yet another object of the present invention to provide a means for attaching a panel to a screen, wherein the panel is used as a visual warning indicating the presence of a mesh screen.

It is still another object of the present invention to provide a means for attaching a panel to a screen, wherein the panel is used as a protective barrier over the entire screen or a replacement section over a portion thereof.

It is furthermore another object of the present invention to provide a means for attaching a panel to a screen that is easily removable, thus separating the panel from the screen, without causing damage to the screen.

It is another object of the present invention to provide a means for repeatedly attaching and detaching a panel to and from a mesh screen.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 shows a front perspective of a screen door of the prior art.

FIG. 2 shows a front view of the decorative surface of a flexible panel of the present invention.

FIG. 3 shows a perspective view of the panel of the present invention partially attached to a screen door.

FIG. 4 shows perspective view of the panel of the present invention fully attached to a screen door.

FIG. 5 shows a cross sectional view of the hook system of the present invention featuring a hook with dual pointed prongs.

FIG. 5A shows an exploded cross sectional view of the hook system of the present invention featuring the preferred embodiment of a hook with dual pointed prongs.

FIG. 5B shows an exploded side cross sectional view of the panel of the present invention with a hook featuring a single pointed prong.

FIG. 5C shows an exploded side cross sectional view of the panel of the present invention with a hook featuring a dual pointed mushroom prongs.

FIG. 5D shows an exploded side cross sectional view of the panel of the present invention with a hook featuring dual pointed arrowhead prongs.

### DETAILED DESCRIPTION OF THE INVENTION

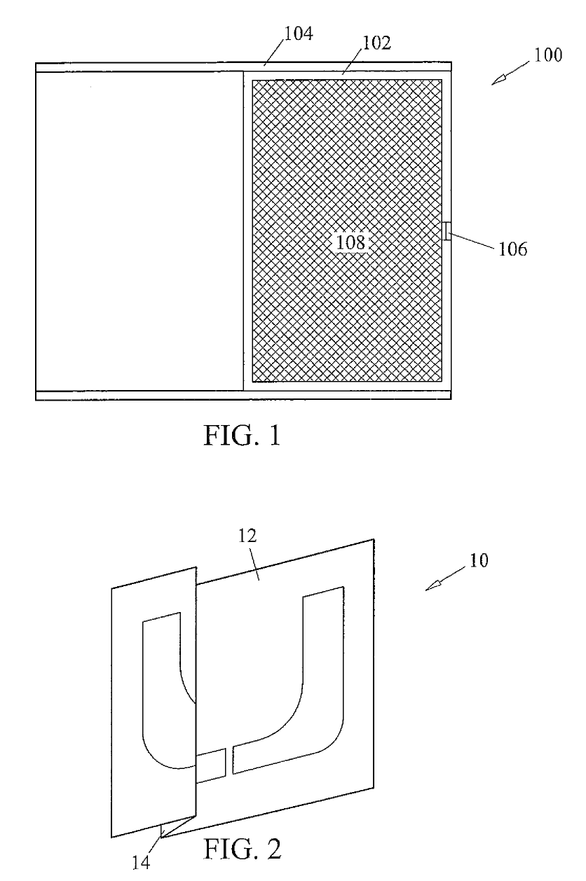

FIG. 1 shows a perspective view of a screen door of the prior art. The screen door 100 includes a frame 102 that is mounted in tracks 104 that extend horizontally across the opening created by the door. The tracks 104 allow for the sliding displacement of the door 100 between open and closed positions. The handle 106 extends from the frame 102 and is operated by the user to aid in displacing the screen door 100 between open and closed positions. The screen 108 is mounted and supported within the frame 102 of the screen door 100. The screen 108 comprises a woven mesh structure that forms a generally planar surface, such that the surface consists of “open” spaces and “closed” spaces. The “closed” spaces consist of the material used to weave the screen. Alternately, the “open” areas allow for the flow of air or light. The main advantage of using a permanent screen 108 to cover a door opening 100 is that air and light can pass through while preventing insects and large airborne particles from gaining access. Screen 108 may be affixed to a door (e.g. screen door) or to fixed supports (e.g. screen enclosure).

FIG. 2 shows a perspective view of the finished side of the flexible panel of the present invention. The panel 10 includes a front or finished side 12 and a rear or fastening side 14. The fastening side 14 is placed adjacent to the screen, where a series of protruding hooks thread are pushed through the open areas of the screen, thereby securing panel 10 to the screen. When attached, the finished side 12 of the panel 10 faces outward from the screen so that the aesthetic design or logo on panel 10 remains in position for viewing. In alternate embodiments of varying designs, constructions, or sizes, the panel 10 will be such that the finished side 12 can be viewed and the fastening side 14 will provide a hook system for attachment to the screen.

The panel 10 can be constructed from any suitable material, or stacked structure of multiple sheets of various materials including but not limited to fabric or screen material. Any material used to construct panel 10 should be moderately flexible and lightweight to allow for the easy connection to screen 108. In a preferred embodiment, the panel can be formed from a layer of screen material. By coupling a panel 10 made of a mesh screen material, alongside screen 108, panel 10 will not prohibit the flow of air or light through the screen. This method is preferred so as to leave the desirable utility functions of the screen intact, while adding aesthetic enhancement.

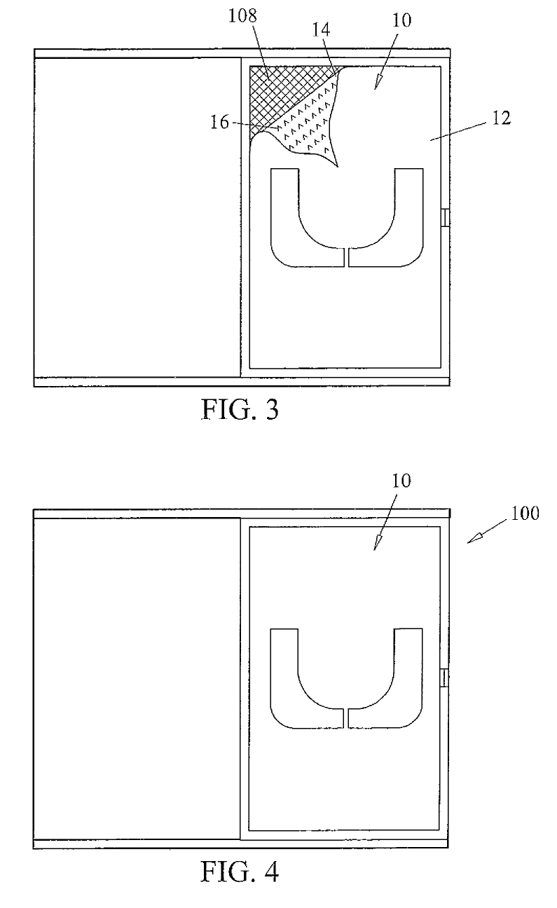

FIG. 3 shows a front perspective view of panel 10 partially fastened to screen 108 of a sliding door as depicted in prior art. The panel 10 adheres directly to the screen 108 by way of an array of resilient hook devices 16 positioned on rear surface 14 of panel 10. Each hook device is sized to allow for insertion between the mesh strands forming the screen so as to removably engage the strands thereby securing panel 10 to screen 108. Panel 10 is not limited to attachment to a screen door. In alternate embodiments, panel 10 may be fastened to any mesh surface, such as window screens or other planar surface formed of fabric comprised of “open” and “closed” areas. Through the use of a series of hooks 16 which extend out from the fastening surface 14 of panel 10, secure adhesion to screen 108 is achieved. In attaching panel 10, fastening surface 14 is placed against a screen 108, causing the hooks 16 to push through or engage the woven surface of screen 108. As described previously, hooks 16 can be of any type with any number of heads, and set in various formations about the fastening surface 14. The finished surface 12 of panel 10 faces outward from screen 108. Panel 10 can be of any size based upon user preference or device function, including a panel 10 that covers the entire screen 108 or a small panel 10 that covers holes or tears of screen 108. In a completely fastened configuration, the entire fastening side 14 of panel 10 is attached directly to the screen 108 so that only the finished side 12 is viewable from the front and all hooks 16 are woven through screen 108.

FIG. 4 shows a front perspective view of panel 10 fully fastened to screen 108 of a sliding screen door such that screen 108 is not readily visible.

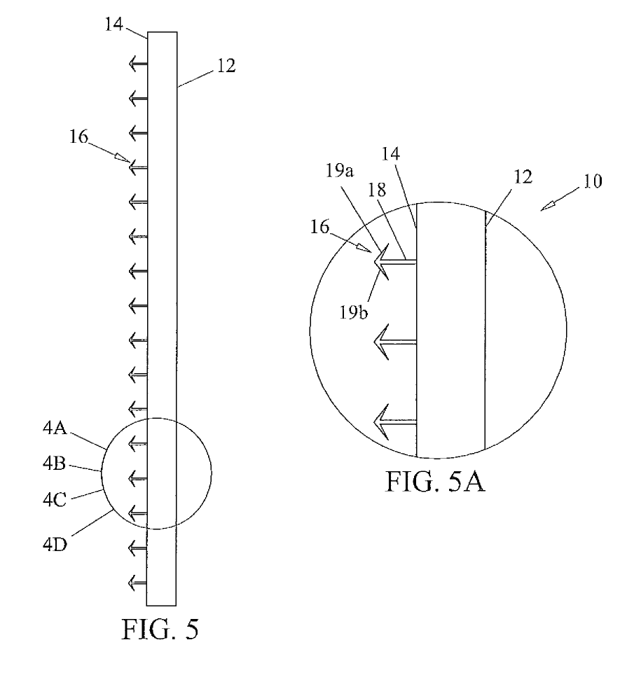

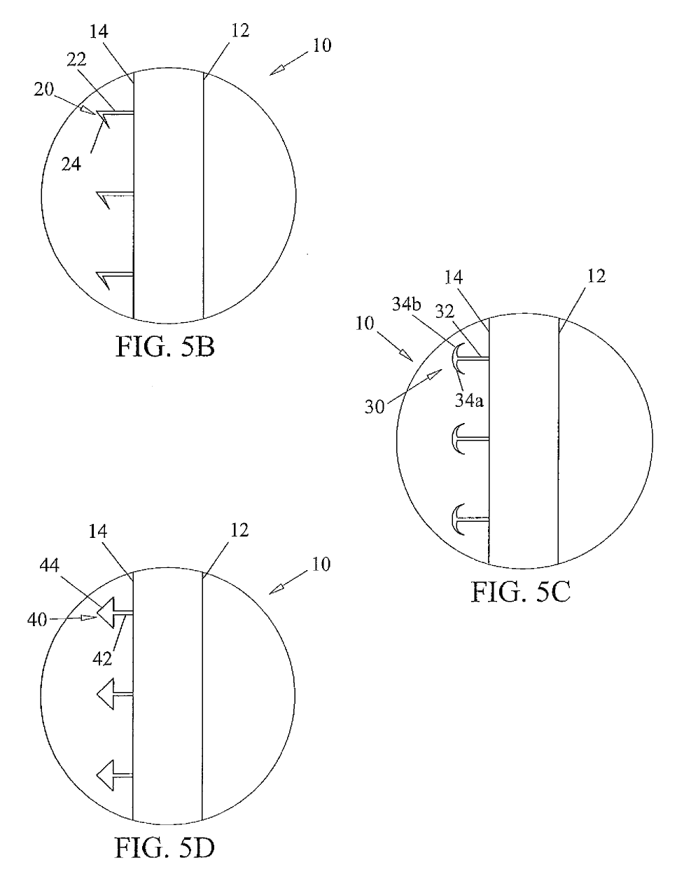

FIG. 5 shows a cross sectional side view of panel 10 showing a preferred configuration of hooks 16 along the surface of the fastening side 14. Hooks 16 extend out perpendicularly from the fastening side 14 of the panel 10 so that ease of engagement with screen 10 can be achieved. Once threaded through, hooks 16 engage about wires that form the screen 108, thereby attaching the panel 10 to the screen. The hooks are made from any suitable material, i.e. wire, metal, or hard plastic, which is sturdy enough to adequately hold the panel against the screen. Furthermore, in a preferred embodiment, the material of hooks 16 should be resilient and pliable enough to allow for the repeated bending of the hooks 16 during adhesion or removal about the screen. Hook placement along the fastening surface 14 is not limited to a set pattern or number of hooks per panel. Hooks 16 can be placed in any pattern such that each hook 16 is able to engage the screen. Moreover, a number of different hook types can be used in securing panel 10 to a screen.

FIG. 5A shows an exploded, side cross sectional view of the preferred embodiment of hooks 16 with a dual pronged hook. Each hook 16 includes a trunk 18 which extends perpendicularly from the fastening surface 14 of panel 10 and prongs 19. Prongs 19a and 19b are attached to the top of the trunk 18 such that they are bent back toward surface 14 at acute angles. Prongs 19a and 19b are pushed through screen 108 “open” areas such that prongs engage the screen and secure attachment is created.

FIG. 5B show an exploded side cross sectional view of alternate embodiment of the panel 10 with a single head pointed hook 20. The single trunk of the hook 22 extends perpendicularly from the fastening surface 14 of panel 10. Prong 24 is attached to the top of the trunk 22 such that it is bent back toward surface 14 at an acute angle. Prong 24 is pushed through screen 108 “open” area such that the prong engages the screen and secure attachment is created.

FIG. 5C shows an exploded side cross sectional view of alternate embodiment of the panel 10 with a dual pointed mushroom prongs 30. The trunk of the hook 32 extends perpendicularly from the fastening surface 14 of panel 10. Prongs 34a and 34b are attached to the top of the trunk 32 such that they are bent back toward surface 14 at concave curved angles. Prongs 34a and 134b are pushed through screen 108 “open” areas such that prongs engage the screen and secure attachment is created. As with the preferred embodiment, the dual head design allows for the hook 30 to engage the mesh webbing at two points on each protruding curved hook head 34a and 34b. By engaging the mesh webbing twice, each hook 30 is capable of supporting more weight.

FIG. 5D shows an exploded side cross sectional view of alternate embodiment of the panel 10 of the present invention that utilizes a dual pronged arrow hook 40. The trunk of the hook 42 extends perpendicularly from the fastening surface 14 of panel 10. The pointed hook 40 is an arrow shaped hook head with a solid triangularly shaped prong 44. Prong 44 is attached to the top of the trunk 42 such that the arrow shape creates a 90 degree angle with the trunk 42, and rests parallel to the fastening surface 14. Prong 44 is pushed through screen 108 “open” areas such that the prong engages the screen and secure attachment is created. The solid construction of hook 40 provides greater strength is securing heavyweight panels to the screen.

The hook designs shown in FIGS. 4A-4D are not limited to the single or dual head designs that are shown, and consist of any number of heads of any design protruding from the end of the trunk of each hook. By increasing the number of heads used in the design of a hook, the number of points of interaction between each hook and the screen is increased, thereby allowing each hook to support a greater amount of weight and ensuring that the panel remains secured to the screen.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. An apparatus for attachment to a building screen having woven mesh strands of material defining openings, said apparatus comprising:
a sheet-like structure having a finished side and an opposing fastening side;
said fastening side including a plurality of hook devices projecting generally perpendicular thereto, each of said hook devices sized for insertion through one of said openings and removable engagement with the strands of said screen.

2. An apparatus according to claim 1, wherein said sheet-like structure comprises a woven screen.

3. An apparatus according to claim 1, wherein the finished of said sheet-like structure includes decorative graphics.

4. An apparatus according to claim 1, wherein each hook includes a proximal end affixed to said fastening side and a trunk projecting from said proximal end generally perpendicular to said fastening side and terminating in at least one prong.

5. An apparatus according to claim 4, wherein said at least one prong projects generally laterally from said trunk and forms and acute angle therewith.

6. An apparatus for attachment to a building screen of the type used on screen doors and enclosures having woven mesh strands of material defining openings, said apparatus comprising:
a flexible sheet-like structure having a finished side and an opposing fastening side, said sheet-like structure defining a plurality of openings therethrough;
said fastening side including a plurality of resilient hook devices projecting generally perpendicular thereto, each of said hook devices sized for insertion through one of the screen openings and removable engagement with the strands of said screen,
whereby said sheet-like structure may be attached to the screen by pressing the fastening side of said sheet-like structure against the screen such that said hook devices are inserted through openings in the screen and removably engage the woven mesh strands of the screen so as to removably secure the sheet-like structure overlayed on the screen.

7. An apparatus according to claim 6, wherein the finished of said sheet-like structure includes decorative graphics.

8. An apparatus according to claim 6, wherein each hook includes a proximal end affixed to said fastening side and a trunk projecting from said proximal end generally perpendicular to said fastening side and terminating in at least one prong.

9. An apparatus according to claim 6, wherein said at least one prong projects generally laterally from said trunk and forms and acute angle therewith.
